(19) United States
(12) Patent Application Publication
(10) Pub. No.: US 2025/0016050 A1
(43) Pub. Date: Jan. 9, 2025

(54) COMPUTERIZED SYSTEMS AND METHODS FOR APPLICATION-BASED QOE NETWORK CONFIGURATION AND IMPLEMENTATION

(71) Applicant: PLUME DESIGN, INC., Palo Alto, CA (US)

(72) Inventors: Miguel VICARIO, Madrid (ES); Alexey GADALIN, Kirkland, WA (US); Ruk SUNDARAMURTHY, Petaluma, CA (US); Kishore TELIDEVARA, San Ramon, CA (US); Derek LOWNSBROUGH, Kelowna BC (CA)

(21) Appl. No.: 18/348,524

(22) Filed: Jul. 7, 2023

(51) Int. Cl. H04L 41/0823; H04L 41/5009; H04L 43/08

(52) U.S. Cl. CPC H04L 41/0823; H04L 41/5009; H04L 43/08

(57) ABSTRACT

Disclosed are systems and methods that provide a computerized network management framework that adaptively configures network parameters/characteristics of a network at a location based on determined intelligence about the network, and/or devices and/or applications executing thereon. The disclosed framework can leverage information related to network capacity and coverage against network activity (e.g., upload/download, streaming, and the like) of devices connected to the network to determine i) which components and/or network activities are causing issues within a network and/or ii) how to configure a network to address/remedy such components and/or activities. Accordingly, the disclosed framework can effectuate control and modifications, and/or capabilities for identifying specific network parameters, firmware, software and/or hardware in order to realize specific configurations of the network to improve the network's quality, capacity and/or coverage, among other characteristics of the network and its operations.

### FIELD OF THE DISCLOSURE

The present disclosure is generally related to network management, and more particularly, to a decision intelligence (DI)-based computerized framework for deterministically managing and/or controlling network components and/or parameters of a network at a location.

### BACKGROUND

Conventional mechanisms of modern network management, as provided by the International Organization for Standardization (ISO), focus on maintaining a Quality of Service (QoS). That is, current network management technologies provide management tools that information technology (IT) professionals can utilize to view network metrics in order to conduct network traffic and/or activities based thereon.

### SUMMARY OF THE DISCLOSURE

The disclosed systems and methods provide an improved computerized network management framework that adaptively identifies and configures network parameters/characteristics of a network at a location based on determined intelligence about the network, and/or devices and/or applications executing thereon. Rather than providing tools for administrators or other types of IT professionals to implement, the disclosed framework enables the network to “self-manage” not only its parameters but the network traffic and interacting entities thereon so as to ensure that both a QoS is maintained, as well as a Quality of Experience (QoE), as discussed herein.

According to some embodiments, as discussed herein, the disclosed framework can leverage information related to network capacity and coverage against network activity (e.g., upload/download, streaming, and the like) of devices connected to the network to determine i) which components and/or network activities are causing issues within a network and/or ii) how to configure a network to address such components and/or activities. Accordingly, in some embodiments, as discussed in more detail below, the disclosed framework can effectuate control and modifications, and/or capabilities for identifying specific network parameters, firmware, software and/or hardware in order to realize specific configurations of the network to improve the network's quality, capacity and/or coverage, among other characteristics of the network.

Accordingly, as discussed herein, the disclosed framework can provide an adaptive network management that involves dynamic, adaptive network configuration functionality and performance control, as well as improved security features.

According to some embodiments, the disclosed framework can effectuate configuration management that involves more than just the management of routers, switches, servers or other pieces of network equipment, in that the framework can additionally provide ongoing tracking of any changes to the configuration of the network. Since configuration issues are one of the major causes of outages, the framework provides novel tools that monitor a network's configuration and performs real-time (and/or historically-based) management to ensure the network's operational integrity. Thus, the disclosed framework can provide and/or administer a wired and/or wireless infrastructure respective to the network hardware and software.

In some embodiments, the disclosed framework can further provide performance management functionality that can ensure proper and/or acceptable service levels in the network to support optimal networking operations. Accordingly, the disclosed framework can perform real-time (and/or historically-based) data collection related to network service quality by tracking performance data on a range of metrics, either through passive monitoring of network traffic or synthetic tests, for example, and execute computerized operations to improve, among other features, packet loss rates and network response times, inter alia.

Moreover, in some embodiments, the disclosed framework's on-site (or “on-premises”), network based diagnostics can realize a security management layer to the network, whereby capabilities related to security management can be provided, which can include, but are not limited to, firewall configuration and management, vulnerability management, intrusion detection systems and unified threat management, and the like.

According to some embodiments, a method is disclosed for a DI-based computerized framework for deterministically managing and/or controlling network components and/or parameters of a network at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically managing and/or controlling network components and/or parameters of a network at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a“network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

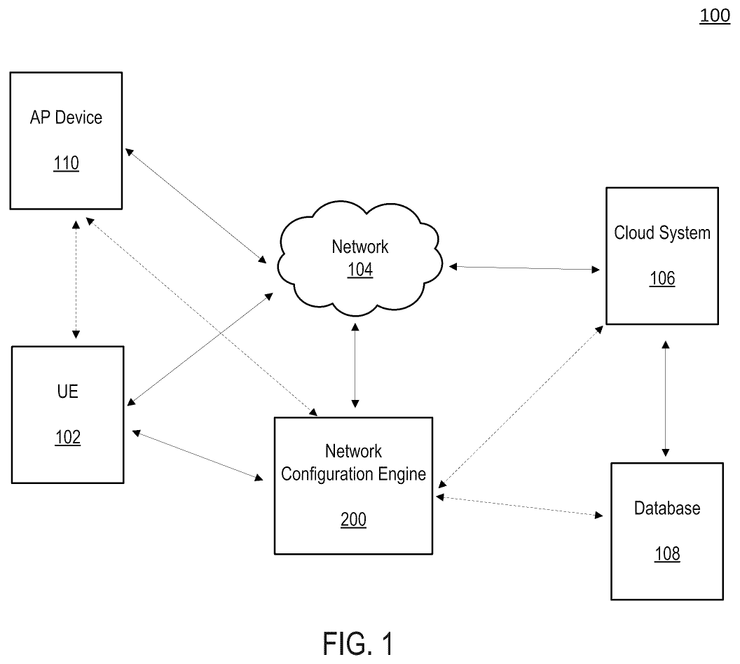

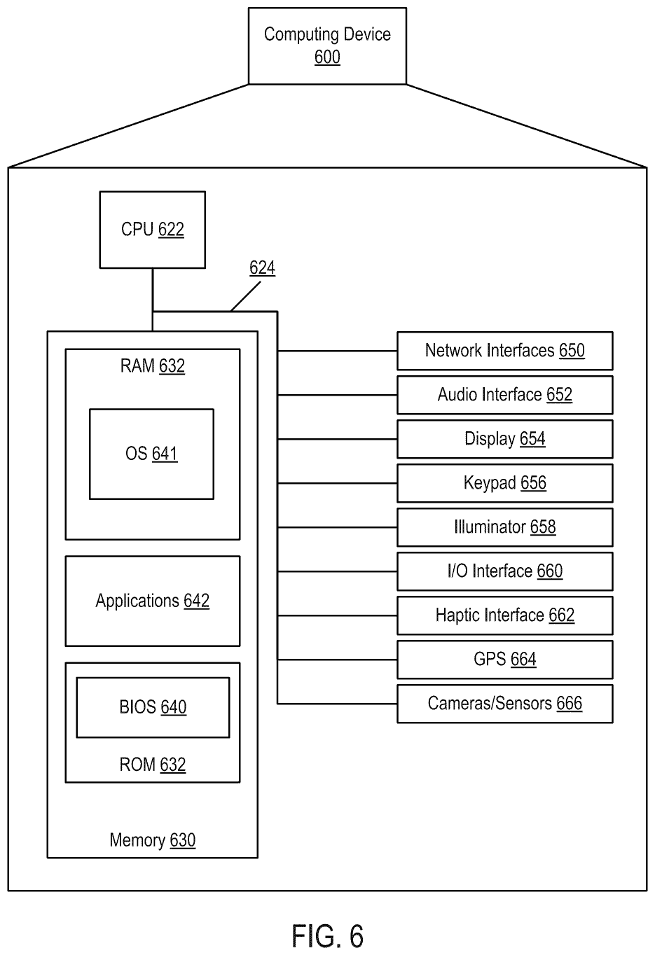

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, access point (AP) device 110 and network configuration engine 200. It should be understood that while system 100 is depicted as including such components, it should not be construed as limiting, as one of ordinary skill in the art would readily understand that varying numbers of UEs, access point devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, access point device (e.g., a router, switch, hub), autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 110 is a device that creates a wireless local area network (WLAN) for the location. According to some embodiments, the AP device 110 can be, but is not limited to, a router, switch, hub and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 110 and the services and applications provided by cloud system 106 and/or network configuration engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

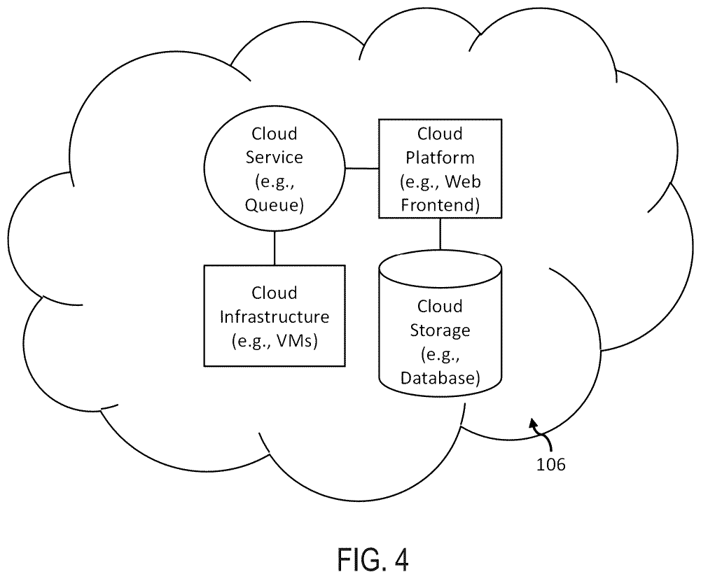

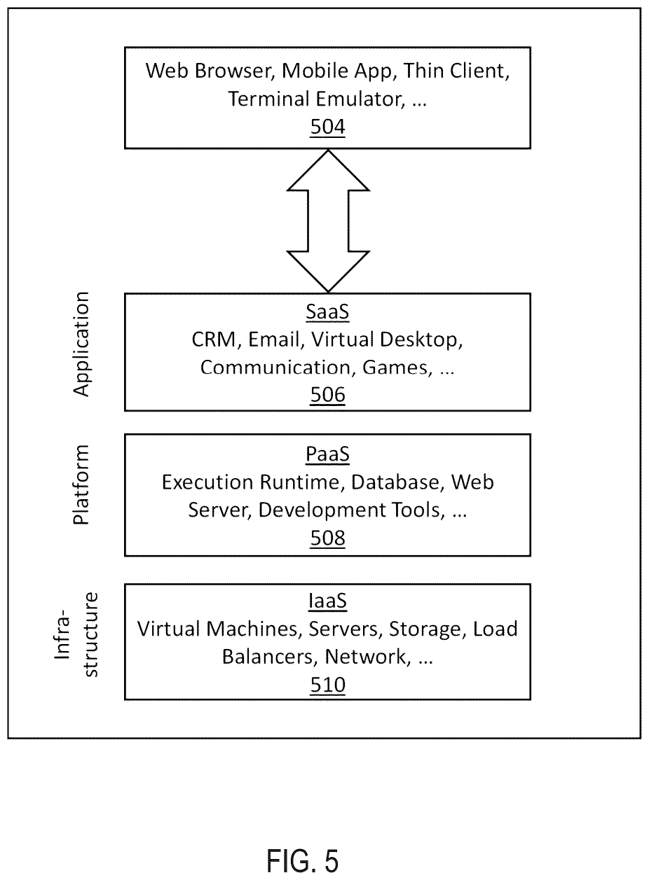

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Network configuration engine 200, as discussed above and further below in more detail, can include components for the disclosed functionality. According to some embodiments, network configuration engine 200 may be a special purpose machine or processor, and can be hosted by a device on network 104, within cloud system 106, on AP device 110 and/or on UE 102. In some embodiments, engine 200 may be hosted by a server and/or set of servers associated with cloud system 106.

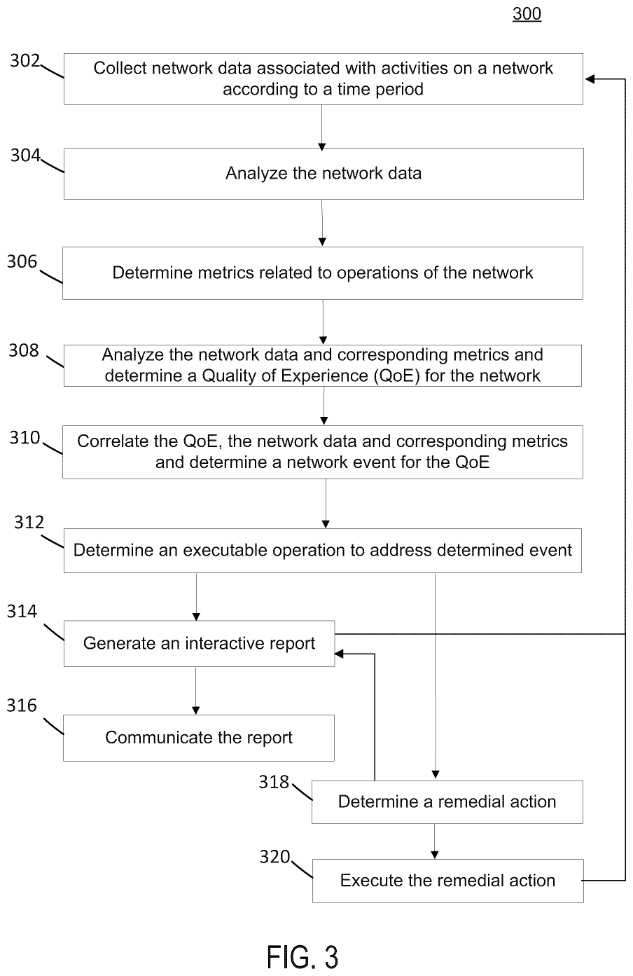

According to some embodiments, as discussed in more detail below, network configuration engine 200 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIGS. 3-4.

According to some embodiments, as discussed above, network configuration engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 and/or AP device 110. In some embodiments, such application may be a web-based application accessed by UE 102 and/or AP device 110 over network 104 from cloud system 106. In some embodiments, engine 200 may be configured and/or installed as an augmenting script, program or application (e.g., a plug-in or extension) to another application or program provided by cloud system 106 and/or executing on UE 102 and/or AP device 110.

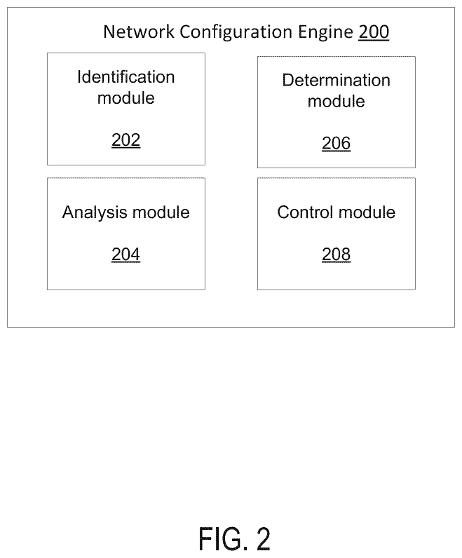

As illustrated in FIG. 2, according to some embodiments, network configuration engine 200 includes identification module 202, analysis module 204, determination module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed network management framework. As discussed herein, the disclosed framework, via engine 200, can effectuate identification of network events and/or conditions that can impact functionality of the network and/or functionality of the devices connected thereto.

According to some embodiments, Step 302 of Process 300 can be performed by identification module 202 of network configuration engine 200; Step 304 can be performed by analysis module 204; Steps 306, 310 and 312 can be performed by determination module; Step 308 can be performed by analysis module 204 and determination module 206; and Steps 314-320 can be performed by control module 208.

According to some embodiments, Process 300 begins with Step 302 where engine 200 can collect network data associated with activities on a network according to a time period. In some embodiments, the time period can correspond to, but is not limited to, a time, date, range of time/date, and the like. In some embodiments, the time period for collection can be triggered via the detection of an event and/or criteria, which can correspond to, but is not limited to, a device connected to the network, a threshold number of devices connecting to the network, an outage (e.g., network speeds dropping below a threshold value), a scheduled time/date, a type of request on the network, a detected amount of bandwidth usage, a detected amount of packet loss and/or packets being transferred, and the like.

In some embodiments, the network data can correspond to any type of data related to network connectivity and/or network traffic, including, but not limited to, downloads, uploads, connections to the network and/or other devices, bandwidth, latency, packet size, transmission power, transmission speed/frequency, and the like. In some embodiments, the network data can be, but is not limited to, specific to users, networks, applications, devices, locations, time periods, and the like, or some combination thereof.

In Step 304, engine 200 can analyze the network data. According to some embodiments, engine 200 can implement any type of known or to be known computational analysis technique, algorithm, mechanism or technology to analyze the collected data from Step 304.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected data, as discussed herein.

According to some embodiments, the AI/ML computational analysis algorithms implemented can be applied and/or executed in a time-based manner, in that collected data for specific time periods can be allocated to such time periods so as to determine patterns of activity (or non-activity) according to a criteria. For example, engine 200 can execute a Bayesian determination for a 24 hour span every 8 hours, so as to segment the day according to applicable patterns, which can be leveraged to determine, derive, extract or otherwise activities/non-activities on the network according to devices/application in/around a location on the location's network.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, in Step 306, based on the analysis performed in Step 304, engine 200 can determine a set of metrics related to operations on the network. The metrics, as discussed herein, can provide a “health” or current operational status of the network so as to indicate how the network is functioning. For example, engine 200 can determine if the network is operating at maximum capacity (e.g., the network is configured to handle 400 MB/s downloads, and currently is operating at 385 MB/s download speeds, for example).

In some embodiments, the metrics can be generated as, but not limited to, items, objects and/or data structures. In some embodiments, the metrics can be scaled, for example, from 0-100, whereby 100 can indicate a highest level of configuration. Thus, from the example above, if the maximum download speed is 400 MB/s, then 385 MB/s can provide a 96 score.

In some embodiments, the scoring may also be configured as indicators as to how the network is actually functioning. For example, a metric for packet loss may be an actual packet loss per a predetermined time period (e.g., x/s loss per second, for example). As above, such information can be compiled and stored as a data structure, which can be stored in database 108, as discussed above.

In Step 308, engine 200 can then determine a QoE for the network. This QoE can provide an indication as to how connected devices, and their associated users, are experiencing the network. In some embodiments, the QoE can provide information related to an operational status of the network, and/or a real-world and/or digital event causing the operational status (e.g., network connectivity, software and/or hardware activity/configurations, respectively, on/over the network causing degradation below network thresholds, as discussed infra). For example, are their requests being timely responded to, are web pages loading correctly, is there pixelation in video feeds, and the like. The QoE can be configured as an information data item or data structure that include information indicating values of how device/user operations are performing on the network. In some embodiments, the QoE can be compiled in a similar manner as discussed above in relation to the metrics.

Accordingly, in some embodiments, engine 200 can implement any of the above AI/ML models, where information related to the network data and their corresponding metrics can be analyzed. Such computational analysis can be performed in a similar manner as discussed in relation to Step 304, discussed supra.

In Step 310, engine 200 can correlate the QoE, network data (from Step 302) and the metrics (from Step 306) based on the analysis in Step 308. Such correlation, as discussed above, can be an output from the AI/ML analysis of Step 308, and can provide a relationship indicator as to why a QoE is at a certain value/level based on the metrics of particular network data. For example, if download speeds are scored at a 96 for network traffic, then transmission frequency parameters can be determined to have a “high” QoE. However, if the packet loss is at or below a threshold, and the metrics indicate as such, then the QoE, which can be “low”, can indicate that pixelation in video streams may be caused by such packet loss. Thus, the QoE can directly correspond to the metrics of specific types of network data, and can provide indicators as to reasonings behind why such metrics are low.

In some embodiments, a QoE can be determined for each network parameter, and in some embodiments, a network can have a corresponding aggregate QoE, where the QoE for each network parameter can be aggregated into a total value from which a QoE can be correlated and determined.

Thus, in some embodiments, as a result of Step 310, engine 200's determination of the QoE can identify deficiencies or issues within/on the network, referred to as events. For example, if the QoE for a time period is “low”, and the time period corresponds to low bandwidth due to too many connected devices streaming media or a detected outage, engine 200 (e.g., via Step 310) can determine that the low bandwidth and/or outage is the root cause. Accordingly, such determination and the corresponding correlated QoE can be stored in database 108, as discussed above.

In Step 312, engine 200 can analyze the QoE and associated event (e.g., the cause of the QoE value) and determine an executable operation to address the determined event. For example, why is bandwidth low, why is packet loss high, why is latency not being optimized, why was there an outage, and the like. In some embodiments, such analysis can involve further analyzing the network data (from Step 302) via the AI/ML techniques discussed above to evaluate and identify issues corresponding to such event. Such analysis/evaluation can correspond to parsing and mining the network data based on a query comprising the event information.

In some embodiments, such analysis can involve pinging, testing or otherwise evaluating network components of an access point of the network (e.g., the router or smart hub conducting the network at the location) to determine if there are operational deficiencies in such component(s). For example, are the transmit (Tx) and/or receive (Rx) antennas in the access point device functioning at levels corresponding to manufacturer settings and/or at levels commensurate with the network's preset/desired configuration. For example, if the QoE and event correspond to interference on the network, Step 312 can involve analyzing the access point device and the network and determining whether the interference is occurring on the network and/or within the access point device.

Accordingly, engine 200, in Step 312, can determine, generate, retrieve or otherwise identify an executable operation to address the event associated with the QoE. For example, engine 200 can query database 108 and determine which operations can be performed to reduce interference. In another non-limiting example, engine 200 can generate a new set of instructions to modify how the Tx and/or Rx antennas are operating, and/or which Tx/Rx antennas are operating so as to mitigate the interference being detected. Accordingly, the executable operation can be embodied as, but not limited to, hardware, software and/or firmware upgrades to the access point(s) providing the network and/or the devices operating on the network. For example, an instruction can cause a user's device to switch channels on the network, which can customize the bandwidth such device is utilizing via such channel.

By way of further non-limiting example, in some embodiments, the executable operations can involve, but are not limited to, executing an optimization operations (or set of instructions) and selectively switching off certain radios (e.g. switch off 5 GHz or 6 GHz radio at a location), reducing the transmit (Tx) and receive (Rx) number of antenna chains for the various radios at the location, reducing power consumption at the cost of reduced antenna diversity, reducing the channel width used for Tx and/or Rx radios, and the like, or some combination thereof. Accordingly, any type of modification to a network component/hardware that can effectuate modifications to how the network operates (e.g., capacity and coverage) can be implemented without departing from the scope of the instant application.

In some embodiments, the executable operations can involve modifications to network components and/or network characteristics which can enable modifications to network performance, which can increase/decrease power savings. Accordingly, changes, modifications and/or limits to ports, communications, antennas, CPU speeds, RAM refresh rates, dynamic spatial multiplexing power save (SMPS) mechanisms, websites/applications, and the like, can be utilized to reduce power and reduce network capacity/coverage. For example, ethernet ports of an access point can be altered from 2.5 Gbps to 100 Mbps based on an operation, which can reduce power consumption while providing the connected devices the adequate network coverage for their tasks. In another example, cloud communication frequency of the access point can be reduced to a lesser frequency, which can also evidence a reduction in network traffic. In yet another example, RAM refresh rates can be reduced to a lower rate, which can lower the power voltage, thereby saving power. And, in yet another non-limiting example, certain applications can be temporarily blocked to prevent overages (according to a threshold per mode) of network traffic per device, which can also lead to network optimization.

In some embodiments, processing of Process 300 can proceed to Step 314, where engine 200 can generate an interactive report. In some embodiments, the information depicted in the visualization can include information related to, but not limited to, the network data, devices on the network, the location, the determined metrics, the QoE, the corresponding event, and/or the executable operation, and the like, or some combination thereof.

In some embodiments, the report can provide dynamic visualizations that correspond to the time period, which interactively “morph” or visualize how the network data has changed or been impacted during the time period. In some embodiments, the report can be provided via a dashboard and/or a user interface (UI) that includes interface objects (IOs) that correspond to the report information (e.g., specific network parameters, for example). For example, graphics can be displayed, which are selectable and can provide supplemental information being displayed that indicate the determined metrics and/or QoE/event information specific to a parameter. For example, a bandwidth IO can be selected which causes the UI to be modified to display a pop-up window or adjacent sidebar/window that provides the determined metrics for the bandwidth during the time period, and which devices on the network are attributing the bandwidth consumption.

Accordingly, in some embodiments, in Step 316, such report can be communicated for display and/or storage (e.g., in database 108). In some embodiments, for example, the communication can be to a service provider providing the network and/or to the devices on the network. Thus, in some embodiments, Step 316 can involve the generation or compilation of an electronic message whereby the report can be included therein, such that upon interaction with the message, the report can be displayed.

Accordingly, as indicated in FIG. 3, upon generation of the report, engine 200 can recursively proceed back to Step 302 for further monitoring of the network, which can be for another or subsequent time period. In some embodiments, the processing of Process 300 can be performed in real-time during the time period, whereby the recursive step of further collection can occur during the time period for further network traffic/data tracking.

In some embodiments, processing can proceed from step 312 to Step 318, where engine 200 can determine the remedial action, which can be based on the executable operation determined in Step 312. Thus, the remedial action determination in Step 318 can enable engine 200 to identify which component to target and/or cause to execute the determined executable operation (from Step 312), whereby in Step 320, engine can execute and/or cause execution of such action. In some embodiments, engine 200 can communicate electronic instructions to a device (e.g., UE or AP) to execute the action, which can be identified and/or included in the instructions, such that remote control of the device can be enabled.

In some embodiments, upon performing Step 318, engine 200 can, in addition to or in the alternative, generate the report as discussed above in relation to Step 318. In some embodiments, upon executing the remedial action in Step 320, engine 200 can recursively proceed back to Step 302 to monitor the impact on the network of the remedial action, which can be during the time period or another time period, as discussed supra.

According to some embodiments, a network can have a dedicated engine 200 model so that the network management protocols applied to the network can be specific to the events and patterns detected on that network. In some embodiments, the model can be specific for a device or set of devices and/or user or set of users (e.g., users that live at a certain location (e.g., a house), and/or are within a proximity to each other (e.g., work on the same floor of an office building, for example)).

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A method comprising:
collecting, by a device, network data for a time period, the network data corresponding to network activity of at least one connected device on a network at a location;
analyzing, by the device, the network data, and determining, based on the analysis, a Quality of Experience (QoE) for the at least one connected device, the QoE comprising information indicating an operational status of the network and an event causing the operational status;
determining, by the device, an executable operation based on the QoE, the executable operation being configured to be performed via the network to address the event; and
causing, by the device, execution of the executable operation, the execution causing a modified network configuration of the network such that the operational status of the network is improved.

2. The method of claim 1, wherein the modified network configuration comprises altered network parameters for the network.

3. The method of claim 1, wherein the modified network configuration comprises altered operation of components providing the network at the location.

4. The method of claim 1, further comprising:
determining, based on the analysis, metrics corresponding to values of the network data, the metrics providing an indication as to an operational status of at least one parameter and component of the network, wherein the QoE is based on the determined metrics.

5. The method of claim 4, further comprising:
correlating, based on the analysis, the network data in view of the determined metrics, wherein the QoE is determined based on the correlation.

6. The method of claim 1, wherein the event is a real-world event corresponds to functionality of hardware components of at least one access point providing the network to the location.

7. The method of claim 1, wherein the event is a digital event corresponds to at least one of functionality of network connectivity of the at least one connected device and software of at least one access point providing the network to the location.

8. The method of claim 1, wherein the network data corresponds to at least one of bandwidth, latency, packet size, transmission power and transmission frequency.

9. The method of claim 1, wherein the operational status corresponds to at least one of a real-world and digital event.

10. The method of claim 1, wherein the event comprises activity on the network causing degradation below network thresholds.

11. The method of claim 1, wherein the device is user equipment connected to the network.

12. The method of claim 1, wherein the device is an access point device, wherein the network is a Wi-Fi network.

13. A device comprising:
a processor configured to:
collect network data for a time period, the network data corresponding to network activity of at least one connected device on a network at a location;
analyze the network data, and determine, based on the analysis, a Quality of Experience (QoE) for the at least one connected device, the QoE comprising information indicating an operational status of the network and an event causing the operational status;
determine an executable operation based on the QoE, the executable operation being configured to be performed via the network to address the event; and
cause execution of the executable operation, the execution causing a modified network configuration of the network such that the operational status of the network is improved.

14. The device of claim 13, wherein the modified network configuration comprises altered network parameters for the network.

15. The device of claim 13, wherein the modified network configuration comprises altered operation of components providing the network at the location.

16. The device of claim 13, wherein the processor is further configured to:
determine, based on the analysis, metrics corresponding to values of the network data, the metrics providing an indication as to an operational status of at least one parameter and component of the network; and
correlate, based on the analysis, the network data in view of the determined metrics, wherein the QoE is determined based on the correlation.

17. A non-transitory computer-readable storage medium tangibly encoded with computer-executable instructions that when executed by a device, perform a method comprising:
collecting, by the device, network data for a time period, the network data corresponding to network activity of at least one connected device on a network at a location;
analyzing, by the device, the network data, and determining, based on the analysis, a Quality of Experience (QoE) for the at least one connected device, the QoE comprising information indicating an operational status of the network and an event causing the operational status;
determining, by the device, an executable operation based on the QoE, the executable operation being configured to be performed via the network to address the event; and
causing, by the device, execution of the executable operation, the execution causing a modified network configuration of the network such that the operational status of the network is improved.

18. The non-transitory computer-readable storage medium of claim 17, wherein the modified network configuration comprises altered network parameters for the network.

19. The non-transitory computer-readable storage medium of claim 17, wherein the modified network configuration comprises altered operation of components providing the network at the location.

20. The non-transitory computer-readable storage medium of claim 17, further comprising:
determining, based on the analysis, metrics corresponding to values of the network data, the metrics providing an indication as to an operational status of at least one parameter and component of the network; and
correlating, based on the analysis, the network data in view of the determined metrics, wherein the QoE is determined based on the correlation.
